(19) United States
(12) Patent Application Publication
(10) Pub. No.: US 2024/0160880 A1
(43) Pub. Date: May 16, 2024

(54) METHOD AND DEVICE FOR FORMING AN IMAGE ON OR IN A PART

(71) Applicant: QIOVA, Andrezieux Boutheon (FR)

(72) Inventors: Sébastien LANDON, La Fouillouse (FR); Yoan DI MAIO, Saint Etienne (FR); Florent THIBAULT, Saint Just Saint Rambert (FR); Benjamin DUSSER, Poncins (FR)

(73) Assignee: QIOVA, Andrezieux Boutheon (FR)

(21) Appl. No.: 18/284,514

(22) PCT Filed: Mar. 29, 2022
(86) PCT No.: PCT/FR2022/050587

§ 371 Date: Sep. 27, 2023

(30) Foreign Application Priority Data
Mar. 29, 2021 (FR) FR2103171

(51) Int. Cl. G06K 19/06; B23K 26/359

(52) U.S. Cl. CPC G06K 19/06159; B23K 26/359

(57) ABSTRACT

The invention relates to a method for creating an image on a surface or in a volume of a part (9), the image comprising a repetition of a pattern (11), the method comprising the following steps: —creating the pattern (11) on the surface or in the volume of the part (9) by shaping and focusing a coherent beam (8A), the pattern comprising at least two local contrast maxima; —carrying out a cycle of the following steps at least once: —moving the beam and the part relative to one another, and —creating the pattern (11) on the surface or in the volume by shaping and focusing the beam such that the patterns created do not overlap. The invention also relates to a system for creating an image on a surface or in a volume of a part using the method.

### CROSS-REFERENCE TO RELATED APPLICATIONS

This application is a U.S. national phase entry of PCT Patent Application Serial No. PCT/FR2022/050587 filed on Mar. 29, 2022, which claims priority to French Patent Application Serial No. FR2103171 filed on Mar. 29, 2021, both of which are incorporated by reference herein.

### TECHNICAL FIELD

The invention relates to the field of laser processing of materials, of glass in particular, with a processing method and a system adapted for industrial production rates, for example allowing the marking of products for applications of traceability and counterfeit protection.

### BACKGROUND

Within the context of a fast expanding marking industry, existing laser technologies have largely been able to prevail by virtue of their ability to machine a large majority of materials allowing most current industrial issues to be met whilst exhibiting strong added value potential in terms of operating parameters and processes. However, there are some markets in which laser technologies have reached their limit, namely those with high speed production rates, examples being the agrifood, pharmaceutical, banknote or electronic sectors generally subjected to the production of items of small size and in very large quantities.

Among existing technologies, some use the combination of a laser source having varied irradiating properties (power, speed, energy, wavelength, pulse duration, etc.), coupled with a deflection head or galvanometer scan head. With this head it is possible both to obtain focusing of the laser beam, i.e. the spatial concentration thereof at a single point, and to obtain controlled, automated movement thereof within the space of the part to be marked similar to that of a pen tip.

Application WO2016001335A1 describes a technology based on the use of a coherent light beam passing through a dynamic optical modulation device to generate a multibeam spatial profile on the surface of the material to be marked. An image formed of several marks can thereby be machined or marked on the surface of the material.

With this technology, the number of marks that can be made in the image is limited by the maximum light energy per pulse. This maximum energy can itself be limited by the damage threshold of the modulation device i.e. the level of light power passing through the device on and after which it is damaged. The maximum energy can also be limited by the maximum power emitted by commercially available lasers.

In addition, the size of images that can be formed is also limited, with the result that it is sometimes difficult to form images having more than 150 marks and/or extending over a surface greater than a few square millimetres. There is therefore a need for a method for marking an image on the surface of a material, glass in particular, without being restricted by the number of marks or the size of the image.

### SUMMARY

It is one objective of the invention to propose a method, via marking or micromachining, for processing an image on the surface or in the volume of a material, glass in particular, the dimensions and/or number of marks in the image not being limited in particular by the technical characteristics of the laser source used and by the constituent material of the target.

This objective is reached in the present invention by means of a method for obtaining an image on the surface or in a volume of a part, the image comprising repetition of a pattern, the method comprising the following steps:
forming the pattern on the surface or in the volume of the part by shaping and focusing a coherent light beam, the pattern comprising at least two local contrast maxima;
carrying out at least once a cycle of the following steps:
   moving the beam and the part relative to each other, and
   forming the pattern on the surface or in the volume by shaping and focusing the beam so that the formed patterns do not overlap.

The method comprises a cycle of steps of which each iteration comprises the emission of the light beam and shaping thereof so as to illuminate a laser pattern at a particular spot on the part. The illumination of the laser pattern marks the part according to the pattern which is not reduced to one mark. It is specified here that the pattern is not necessarily identical to the laser pattern; this difference is detailed below.

From one iteration to the next, the spot on the part struck by the light beam is modified, which means that it is possible to form a more extended image than the pattern and comprising more marks than the pattern. The cycle can be repeated at will, so that the dimensions of the image finally formed on the part and the number of marks contained therein are not limited by the technical characteristics of the laser source used and by the constituent material of the target.

Said method is advantageously completed by the following different characteristics taken alone or in combination:
the pattern is formed of a plurality of spatially separated marks;
the coherent light beam is pulsed, each forming of the pattern comprising the emission of a burst of at least one laser pulse, each burst comprising a number of laser pulses inferior to the number of marks forming the pattern;
each burst comprises a single laser pulse;
the image represents a one- or two-dimensional code composed of an assembly of empty cells and filled cells, the cells being located at predetermined positions;
the filled cells comprise the pattern one or more times;
moving the beam and the part relative to each other is performed over a length greater than a dimension of the pattern;
moving the beam and the part relative to each other is performed over a length less than a dimension of the pattern;
the image comprises a repetition of a second pattern, the second pattern comprising at least two local contrast maxima, the method further comprising the performing of the following steps:
   forming the second pattern on the surface or in the volume of the part by shaping and focusing a coherent light beam;
   carrying out at least once a cycle of the following steps:
      moving the beam and the part relative to each other, and
   forming the second pattern on the surface or in the volume by shaping and focusing the beam, so that the two formed patterns do not overlap;
the image comprises an additional pattern formed of a plurality of marks, the method further comprising the forming of the additional pattern on the surface or in the volume of the part by shaping and focusing a pulsed coherent light beam, wherein the forming of the additional pattern on or in the part comprises the emission of a pulse train of the light beam, each train comprising a finite number of pulses strictly inferior to the number of marks forming the additional pattern;
the part is in glass, in metal, in plastic or polymer;
when forming the pattern, the method comprises a modification of a first layer of material by exposure to the laser so as to expose a second layer lying underneath the first layer;
the forming of the pattern on the surface or in the volume takes place in a processing plane, the processing plane being separated from a focusing plane of the laser beam by a distance inferior or equal to one half of a focal length of a focusing device, the focusing device defining the position of the focusing plane;
a step to compute a set modulation value from a set input value corresponding to the pattern, the set modulation value being imposed on a modulation device to carry out the shaping of the beam.

The invention also relates to a part comprising an image formed by the method such as described in the foregoing. Finally, the invention relates to a system for forming an image on a surface or in a volume of a part, the image comprising repetition of a pattern, the system comprising:
a device for forming the pattern on the surface or in the volume of the part by shaping and focusing a coherent light beam, the pattern comprising at least two local contrast maxima; and
a device for moving the beam and the part relative to each other.
   Said system is advantageously completed by the following different characteristics taken alone or in combination:
the device for forming the pattern on the surface or in the volume of the part by shaping and focusing a coherent light beam comprises:
   a source of a coherent light beam;
   an optical modulation device comprising means to modulate the light beam, in a modulation plane, according to at least one phase modulation to shape the light beam in a laser pattern;
   a focusing device configured to focus the light beam shaped by the modulation device in a focusing plane, the focusing plane having Fourier or Fresnel configuration relative to the modulation plane of the modulation device, the system being adapted to receive the part, so that the forming of the pattern on the surface or in the volume takes place in a processing plane, the processing plane being separated from the focusing plane by a distance less than or equal to one half of a focal length of the focusing device,
the laser pattern being configured to produce processing of the part in accordance with the pattern in the processing plane;
the laser beam is pulsed;
the optical modulation device comprises fixed shaping optics;
the optical modulation device and the focusing device are grouped together in a single apparatus;
the relative motion device comprises a galvanometer scan head;
the relative motion device comprises at least one translation stage.

### BRIEF DESCRIPTION OF THE DRAWINGS

Several nonlimiting embodiments are presented below in connection with the appended drawings in which:

FIG. 1 is a schematic illustration of a system for forming an image according to the different embodiments of the invention.

FIGS. 2 and 3 are schematic illustrations of two types of marking according to a first and a second embodiment respectively of the invention.

FIGS. 4A and 4B illustrate two patterns according to the first embodiment of the invention.

FIG. 5 comprises illustrations 5A, 5B, 5C, 5D and 5E of markings formed on glass according to the first embodiment of the invention.

FIGS. 6 and 7 are illustrations of a secure QR-code.

FIGS. 8 and 9 are examples of the forming of a secure QR-code according to a third embodiment of the invention.

### DETAILED DESCRIPTION

The present invention relates to the processing of materials i.e. the structural modification of materials by laser on a small scale having regard to the dimensions of the material. Image forming or processing is defined as the marking of an image by laser i.e. modification of the material by laser to generate:
an optical contrast in accordance with the image on the surface or in the volume of the part, or else
image micro-machining by laser i.e. modification of the material by laser to generate surface relief on the part, or a variation in density in the volume of the part (by ablation or addition of material) in accordance with the image.

One particular case of image micro-machining, if the material is composed of several layers of different type, is to remove one of the layers to expose the underlying layer. In other words, when forming the image, processing comprises a modification by exposing a first layer of material to the laser to expose a second layer lying underneath the first layer. This particular case is of interest when the optical rendering of the two layers (colour, shine, etc.) is significantly different. This case is not limited to the processing of the outermost layers; as an example, mention is made of the removal of a layer of coloured paint underneath a varnish layer to expose another coloured layer of different hue.

The image is a spatial distribution of an optical contrast function. Once processed, the image can be detected by optical measuring means. The image is of a certain size and certain resolution. Resolution can be defined as the minimum size of detail that is able to be detected in this image. Resolution can differ in the three dimensions; the notions particularly used are transverse resolution (i.e. in the directions perpendicular to the direction of propagation of the laser beam) and depth resolution (i.e. in the direction of propagation of the laser beam).

In general, the image extends over a surface which is not necessarily planar and does not necessarily merge with the outer surface of the part. The following description is given for the particular example of processing that entails surface marking, considering that the image extends over a planar working surface, but the invention is not in any way limited to this particular example and concerns the entire field of such processing.

The image to be formed comprises repetition of a pattern without overlap. A pattern is a spatial distribution of an optical contrast function on the outer surface of the part, such distribution being denoted C(x,y) dependent on the spatial coordinates x, y. Coordinates x and y correspond to transverse directions perpendicular to the direction of propagation of the beam. In this case, the pattern extends over a plane perpendicular to the direction of propagation of the beam.

The pattern can also extend over a plane that is inclined relative to a plane perpendicular to the direction of propagation of the beam, but without being parallel to the direction of propagation. More generally, the pattern can extend over a surface which is not planar but without being parallel to the direction of propagation. It is then possible to define an equation of this planar or non-planar surface in the form of z=S(x,y) which, for every point of the surface of spatial coordinates x, y, gives the coordinate z of this point, the coordinate z corresponding to the direction of propagation of the beam. The distribution C(x,y) then gives the contrast C(x,y) for the point on the surface of coordinates (x, y, z=S(x,y)). A repetition of the pattern is a spatial distribution obtained by summing several distributions C spatially offset from each other: C(x+a₁, y+b₁)+C(x+a₂, y+b₂)+ . . . +C(x+aₙ, y+bₙ).

A repetition of the pattern is without overlap when no contrast zone of a first distribution overlaps a contrast zone of a second distribution. There is no superimposition between contrast zones of two different distributions. A contrast zone of one distribution is a spatial zone in which the distribution has values differing significantly from zero, so that it is able to be optically identified as being a zone differing from the places where the value of distribution is zero. In other words, a repetition of the pattern is without overlap if, at a point where one of the summed distributions C has a nonzero value, then at this point the value of all the other distributions is zero.

The pattern comprises at least two local contrast maxima, which means that the spatial distribution of the contrast function exhibits at least two local maxima. The spatial distribution of the contrast function reaches a local maximum at a point where the distribution has a given value, when around this point the contrast function has values lower than or equal to this given value. In other words, the spatial distribution C (x,y) of the contrast function reaches a local maximum at a point (x₀, y₀) if there exists a neighbourhood V of the point (x₀, y₀) such that for every element (x,y) of V, there is C(x,y)≤C(x₀, y₀).

The pattern comprises at least two local contrast maxima, the values of these two local contrast maxima possibly being the same or different. The pattern can be discrete i.e. it is formed of a plurality of spatially separated marks or separated dots. In other words, the pattern is composed of contrast zones that are distinctly localized and spatially separated from each other. The spatial distribution of the contrast function then has separated peaks corresponding to each of these zones. Optically, said pattern appears as being formed of a plurality of marks.

The pattern can be continuous i.e. it is composed of one or more contrast zones that are more spread out. The spatial distribution of the contrast function then appears as high contrast plateaux corresponding to each of these spread-out contrast zones. Optically, said pattern appears as being formed of a surface or an assembly of surfaces. The pattern extends over a certain dimension which is strictly greater than the transverse resolution of the image.

The method comprises a first processing step of the pattern on a surface or in a volume of the part by shaping and focusing a coherent light beam that is optionally pulsed. At this first step, a coherent light beam is emitted and the spatial energy distribution thereof is modified in a plane orthogonal to its direction of propagation. The spatial energy distribution of the light beam in the plane of the part to be marked forms a laser pattern. The illumination of the part by the laser pattern allows forming of the discrete or continuous pattern of which all the contrast zones are processed at the same time on the surface or in the volume of the part to be marked.

Coherent Light Beam

A source is used allowing the emission of a spatially and temporally coherent light beam, such as a laser beam. For example, a standard laser source can be used not having any particular specificity.

The light beam can be continuous or pulsed. A pulsed beam is temporally composed of a succession of pulses. Also, the emission can be controlled so that the beam is emitted in the form of pulse trains, also called bursts, shots. A pulse train is formed of a finite number of pulses of the light beam.

The present system is compatible with the different laser firing modes currently existing such as described in application WO2016001335A. For a pulsed beam, pulse duration can be controlled to have a preferable value of between 100 femtoseconds (fs) and 1 microsecond (μs). The range of pulse durations [100 fs-10 picoseconds (ps)] is of interest for marking glass and more generally transparent materials. It is thus possible to limit mechanical defects or damage generally known as micro-cracks which can occur when marking with pulses of longer duration.

The range of pulse durations [10 ps-1 μs] is compatible with most light sources, laser in particular, which are widely present in the industrial sector. These pulse durations are also compatible with high energy quantities which can be useful for marking some materials with an image having numerous marks using a very low number of pulses. The emission of the light beam is preferably controlled so that each pulse has a determined energy of between 1 μJ and 100 mJ. Also preferably, the emission of the light beam is controlled so that the pulse train delivers a mean power of between 1 μW and 5000 W.

Beam Shaping by Phase Modulation

To shape the beam, there is provided a modulator or modulating device. The latter allows spatial modulation of the light beam in particular to control the shape of this beam i.e. its spatial distribution of optical energy, to create a laser pattern which, by striking the part in a marking plane corresponding to the marking plane on the material, will produce a discrete or continuous pattern. The modulator is an optical element allowing spatial modulation of laser optical radiation. The modulation used can concern the amplitude and/or phase and/or polarization of radiation, whether or not independently. Preferably, at least one phase modulation is always performed that can optionally be completed by amplitude modulation or modulation of radiation polarization. Preferably, the modulator allows phase modulation of the light beam in the plane of the modulator. Depending on particular marking modes, preference is given to pure phase modulation.

The modulation plane is defined as the plane of the modulator in which the magnitude of the modulated laser beam (amplitude and/or phase and/or polarization) is controlled. This control in the modulation plane is performed sector by sector, or in other words pixel per pixel. The coherence of the light beam is maintained between upstream and downstream of the modulator.

The modulation applied to the beam in the modulation plane generates sub-beams downstream. The shaping plane is defined as the plane having Fourier configuration with the modulation plane. The different sub-beams generated in the modulation plane appear in the desired spatial distribution of optical energy in the shaping plane.

In other words, the modulating device in the modulation plane inserts a modulation of a magnitude of the beam which produces sub-beams in this plane, these sub-beams producing the desired shape of the beam in the shaping plane i.e. the desired spatial distribution of optical energy. This distribution of energy appears as the laser pattern on the plane of the part to be processed.

A first type of modulator able to be used for this purpose corresponds to fixed shaping optics, and in particular to Diffractive Optical Elements abbreviated to DOEs. It is specified that in this case the focusing of the beam described below can be integrated in the DOE.

A second type of modulator able to be used is routinely known by its acronym SLM (“Spatial Light Modulator”) irrespective of the technology applied to obtain said modulation. This type of modulator, the underlying technologies and the type of configuration applied to the pathway of the optical beam (imaging configuration or Fourier configuration) are described in application WO2016001335A. It is added here that SLM modulators can be controlled for example by software, to modify the modulation of the light beam passing through it. The characteristic time for changing from one modulation to another is typically between 1 millisecond (ms) and 100 ms, corresponding to a frequency of between 10 Hz and 1000 Hz.

Transport, Adaptation and Focusing of the Beam

The optical pathway before and after the modulation device is composed of an assembly of optical elements such as presented in application WO2016001335A. It is to be noted that downstream of the modulator, an assembly of elements can be chosen:
“virtually” to adapt the characteristics of the modulator, and
to focus laser radiation in a focusing plane. The focusing device is generally industrially defined by a focal length, a working distance, and an associated focal plane, given for specific optical conditions (wavelength, infinite imaging, refractive index, and dioptre curvature). In this description, by focusing plane it is meant the plane of the light beam having the least surface i.e. the plane where light energy is the most concentrated.

The processing plane or working plane is defined as the plane where there extends the pattern to be formed, and where the processing of this pattern takes place. It is to be noted that, from one pattern to another, the processing plane can differ. This is particularly the case when the image extends over a surface which is not planar. The processing plane may or may not coincide with the shaping plane, and may or may not coincide with the focusing plane.

When the focusing plane corresponds to the shaping plane, the configuration is said to be a Fourier configuration. When these planes differ, the configuration is said to be a Fresnel configuration.

The distribution of light energy in the processing plane is called the laser pattern. The impact of the laser pattern on the part in the processing plane leads to processing in accordance with the pattern. The pattern is not necessarily identical to the laser pattern, the latter itself not necessarily identical to the spatial energy distribution created by the modulator in the shaping plane. On the part, it is only at the points of the laser pattern where incident light intensity exceeds a certain process intensity threshold that processing of the material of the part takes place.

The resolution of the processed pattern is dependent on the following elements:
beam power,
beam size,
energy distribution according to the laser pattern,
properties of the material, and
the technique and configuration used (illumination, optics) to capture the contrast image.

Motion and Processing Cycle

Once the first step of pattern processing is completed, the method continues with the performing of at least one cycle of the following steps:
moving the beam and the part relative to each other, and
processing the pattern onto the surface or in the volume by shaping and focusing the beam.

The method is adapted so that all the patterns formed throughout the method do not overlap. In other words, the repetition of the pattern is without overlap i.e. as seen above, no contrast zone of a first distribution overlaps any contrast zone of a second distribution. In this manner, an image is obtained comprising repetition of a pattern without overlap.

Relative Movement of the Beam and the Target

The system for forming an image may comprise a device to move the beam and the part relative to each other, to control and automate the position of the impact of the light beam on the part to be marked. Said motion device can be a device having a galvanometer scan head. This technology is based on the mechanical movement of optics (mirrors, prisms, discs, polygons . . . ).

Said motion device can be a motorized mechanical translation stage or an assembly of several stages. The part to be machined can be carried by, or at least rigidly connected to this stage or stages. In this manner a moving stage, via the movement thereof, drives the part to be machined.

The use of these mechanical devices entails a limit on the performance time of the step to move the beam and the part relative to each other. Such movement can scarcely be carried out in a time of less than 500 microseconds (μs), or else would require a most costly installation.

The frequency of 2 kHz associated with this minimum movement time impacts the speed of production of the patterns in the method for forming the image. Therefore, the more the marking of the pattern is ensured by a low number of pulses produced by a pulsed light source, the lesser the advantage of having recourse to a source which emits pulse trains at frequencies much higher than 2 kHz in order to accelerate the method.

In particular, there is an advantage in using a method in which an image is formed by performing a cycle of pattern processing and relative movement, when it is faster to mark a pattern with a laser pattern and a pulse burst, than to mark the pattern mark by mark with relative movement between two markings.

The performing of several movement and processing cycles allows the forming of as many patterns on the part. The formed patterns are spatially distributed in accordance with the relative movements. The method can be halted when all the patterns contained in the image are marked on the part.

Number of Pulses Per Pattern

Each processing step of the pattern on a surface or in a volume of the part by shaping and focusing a pulsed coherent light beam corresponds to the emission of a pulse train (or pulse burst or pulse firing) comprising one or more pulses of the beam which come to strike the material. The duration of this step can be limited by using a single pulse per processing. This assumes that the processing of the pattern formed by a single pulse allows the desired result to be reached (marking contrast, depth of ablation, etc.). The result of processing the pattern from a burst comprising a single pulse is dependent in particular on the constituent material of the part, the amount of energy contained in the pulse, the size of the pattern to be formed, and the wavelength of the laser.

For example, if processing involves marking, the contrast is generally greater the higher the quantity of energy contained in the pulse. If the energy input into the modulation device is considered to be constant, then the contrast will be greater the lower the number of marks in the pattern and the smaller the expanse of the surface or surfaces forming the pattern. More generally, when marking of a pattern is produced by a burst comprising several pulses, the contrast is greater the higher the quantity of energy contained per pulse and the higher the number of pulses in a burst. For a given quantity of energy per pulse input into the modulation device, it can be advantageous to reduce the number of marks forming the pattern, and the expanse of the surface of surfaces forming the pattern, so that a single pulse produces the pattern with sufficient contrast.

Type De Images

The image to be formed comprises the repetition of a pattern which can be discrete or continuous. If the pattern is discrete, each processing is the simultaneous processing of several marks i.e. of several distinctly localized contrast zones. Said processing can be designated by the term “multimark processing” and can be performed by dividing the laser light beam into several sub-beams each allowing the marking of one of the marks of the pattern.

The image to be formed comprises the repetition of a pattern according to a plurality of predetermined offsets. At each step of relative movement, the part is moved relative to the beam according to one of the offsets of the plurality of predetermined offsets. The image can be exactly composed of repetition of the pattern. In this case, when the pattern is repeated n times in the image, the repetition of n steps of pattern processing, and of (n−1) relative movements, allows the obtaining of the final image.

When the coherent light beam is pulsed, in one particular embodiment of the method, each processing of the pattern comprises the emission of a burst of at least one laser pulse, each burst comprising a number of laser pulses lower than the number of marks forming the pattern. Preferably, each burst comprises a single laser pulse. In this manner, the processing is completed faster than with conventional mark-by-mark processing with the same laser speed.

1D or 2D Codes

The image is exactly composed of the repetition of the pattern if the image represents a one-dimensional code (bar code) or a two-dimensional code (2D code). A 2D code is composed of an assembly of cells placed at predetermined positions, some cells being empty and the others being filled. A distinction is made herein between the term “two-dimensional coding” (2D coding) which corresponds to an organization of an assembly of cells each having to be either empty or filled, and the term “2D code” which is a particular implementation or particular obtaining of 2D coding. A 2D code is therefore a particular choice of empty cells and filled cells according to the organization of the 2D coding, and which translates the content of the code.

Some 2D codings are based on a Cartesian organization, all the cells being a square or rectangular matrix with cells organized into rows and columns. This is the case for example of the Data Matrix code or QR-code. There exist other 2D codings in which the cells are organized on a “honeycomb” base (as in dot-code or maxicode) or on a polar base (as in shotcode or spotcode). The assembly of cells can have central symmetry for example. In all 2D codings, each cell of a 2D code is either empty or filled.

The method can be adapted so that the pattern corresponds to the content of a filled cell. The filled cells are therefore filled with only the pattern. Each processing step corresponds to the obtaining of a filled cell. In this case, between each of the treatment steps, relative movement takes place at least over the minimum distance separating two neighbouring cells in the assembly of cells of the 2D coding. Since these cells do not overlap, each relative movement of the beam and the part takes place over a length greater than a total dimension of the pattern.

“Brush” or “Pixel Stamp” Marking

More generally, the methods for forming the image in which relative movement always takes place over a length greater that a total dimension of the pattern can be designated by the term “brush” marking or the equivalent term “Pixel stamp” marking, which is a first embodiment of the invention. The principle of brush or Pixel stamp marking is the decomposing of the image into a juxtaposition of several identical patterns. The image is then obtained by a succession of laser bursts, each burst being composed of one of more laser pulses and preferably composed of a single laser pulse, each burst marking a pattern.

FIG. 2 schematically illustrates brush or Pixel stamp marking. The pattern SM1 is composed of a square of four marks aligned in two rows and two columns. All the relative movements to be carried out are represented by the matrix D1, each cross in the matrix representing a position of a pattern to be formed.

The image M to be formed is obtained by replacing each cross in the D1 matrix by the SM1 pattern. It is to be noted that every relative movement i.e. every distance between two crosses in the D1 matrix has a length greater than the size of the SM1 pattern.

One advantage of using brush marking or Pixel stamp marking lies in the marking of different 2D codes of one same 2D coding. Since the pattern to be formed is always the same irrespective of the 2D codes, it is not necessary to modify the shaping of the beam from one 2D code to the other. In particular, if different parts are marked, each part having its particular 2D code for example associated with a serial number, there is no need to modify the shaping of the beam from one part to the other.

Considering the relative slowing of production caused by modifying beam shaping, this makes it possible to carry out faster individual marking of a large number of parts. By individual marking it is meant marking whereby each part is marked with a unique 2D code.

In addition, the forming of a pattern which is reduced to the filling of cells of 2D coding requires relatively low energy. The marking of said pattern can be therefore be relatively easily carried out with a single pulse of the light beam. Also, a wide choice of light sources is able to be used for said marking.

It is therefore possible to reach relatively short marking times, typically of less than one second. Finally, the size of the image is not limited by the size of the pattern, and images having a typical size of 100 mm×100 mm can be obtained.

Performing Data Matrix on Glass

An example is given here of marking a 2D code on glass bottles (borosilicate and soda-lime) at ambient temperature using brush or Pixel stamp marking under the conditions listed below. These bottles sometimes have additional mass or surface treatment such as the deposit of a varnish or paint layer before the marking phase. In this example, the objective is the marking of a 2D Data Matrix code of varying content and varying size but typically within a range of magnitudes of 100 μm-10 cm.

In this case of application, the formed pattern represents either a square composed of four marks aligned in two rows and two columns, or a square of nine marks aligned in three rows and three columns. Marking is carried out using the modulator to shape the incident coherent light beam so as to define four or nine marks respectively in the processing plane, in other words four or nine distinctly localized contrast zones.

FIG. 4A illustrates an elementary pattern of brush of Pixel stamp marking in a square composed of 2×2=4 marks, in other words of four distinctly localized contrast zones. FIG. 4B illustrates an elementary pattern of brush or Pixel stamp marking in a square composed of 3×3=9 marks, in other words of nine distinctly localized contrast zones. In these Figures, the distance between the marks in the shaping plane can have different values within the range of magnitudes of 1 μm to 100 μm.

The laser source used has the following characteristics:
a pulse duration time of between 150 fs and 10 ps, preferably between 1 ps and 10 ps,
near InfraRed (IR) wavelength of 1030 nm,
energy level per pulse of:
   200 μJ-300 μJ for the 2×2 pattern, and
   500 μJ-700 μJ for the 3×3 elementary pattern;
each pattern is marked using between 1 and 10 laser pulses.

The relative movement between the laser and the target was obtained using translation stages positioned underneath the glass bottle. The point of laser impact was therefore fixed in space.

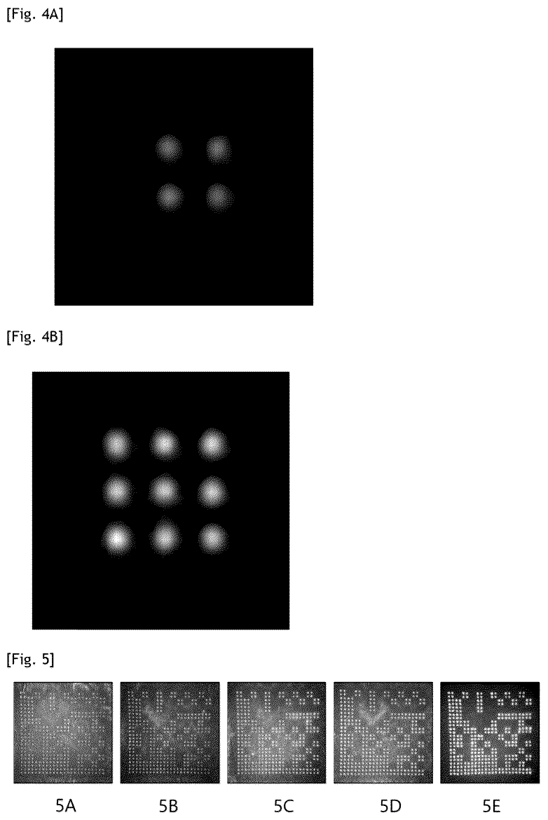

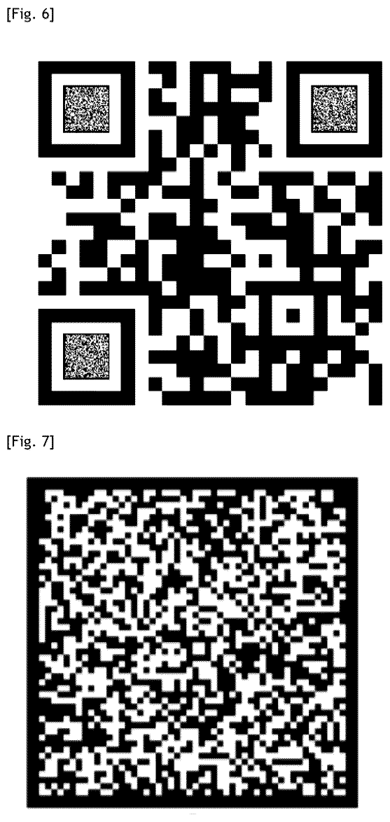

Examples of markings made, in particular by varying the number of pulses in each laser burst (from 1 to 10 pulses) can be seen in the illustrations 5A to 5E in FIG. 5. Illustration 5A corresponds to one pulse, illustration 5B to two pulses, illustration 5C to three pulses, illustration 5D to five pulses and illustration 5E to ten pulses.

It is to be noted that the contrast of marking increases when:
the number of pulses per burst increases;
the quantity of energy contained in each sub-beam increases; and
the pattern extends over a smaller surface.

The tolerance for positioning of the part to be marked along the optical axis appears close to 1 mm. In other words, the marked pattern is of satisfactory shape and contrast, even if the part is placed forward or back over a range of 0.5 mm relative to the position of the shaping plane. In other words, if the distance between the working plane and the shaping plane is less than 0.5 mm, the shape and contrast of the processed pattern are satisfactory. This tolerance of 1 mm appears to be significantly higher than known solutions for the marking of glass.

In addition, the surface area of the part surrounding the points of laser impact does not show any mechanical damage of micro-crack type, which is usually encountered when treating glass with laser.

“Wobbling” Marking

The methods of forming the image in which relative movement always take place over a length shorter than a total dimension of the pattern can be designated by the term “wobbling” marking. In this second embodiment of the invention, each pattern extends over a certain bounding surface and there is overlap between the bounding surfaces of two successively formed patterns.

The bounding surface over which a pattern extends is understood for example to be the minimum continuous surface covering all the marks of the pattern, whether these marks are distributed in discrete or continuous fashion. In other words, the bounding surface over which the pattern extends can be the minimum continuous surface covering either all the marks forming the pattern, or the continuous surface or surfaces forming the pattern.

The overlapping of the bounding surfaces of the patterns does not mean repetition of the pattern with overlap. The corresponding patterns do not necessarily overlap. For example, the pattern is a spatial distribution of a contrast function which can be composed of distinctly localized contrast zones i.e a plurality of separated marks. The marks are spatially spaced apart from each other by at least a minimum separation distance. The minimum separation distance is less than a total dimension, length or width, of the pattern. It can be less than one half, one quarter or even less than 1/10 or 1/20 of this total dimension. If a second pattern is applied, formed of a second plurality of marks, offset from the first pattern by a length less than the minimum separation distance, then:
there is no overlap of marks between the first and second plurality of marks, and
there is overlap of the surfaces on which there extend the first and second patterns respectively.

FIG. 3 schematically illustrates marking by wobbling. The pattern SM2 is composed of a plurality of discrete marks distributed in a square, the surface of which is very close to that of the image. All the relative movements to be carried out are illustrated by the 2D matrix, each cross in the matrix representing a position of a pattern to be formed. The 2D matrix comprises four crosses distributed in two rows and two columns.

The image M to be formed is obtained by replacing each cross of the 2D matrix by the pattern SM2. It is to be noted that the length of any relative movement i.e. any distance between two crosses in the 2D matrix is less than the size of the pattern SM2 and less than the minimum distance separating two marks in the pattern SM2.

Wobble marking is adapted to cases in which the image and hence the pattern is of relatively large size i.e. when there is a high number of points forming the pattern or when the expanse of the surface or surfaces forming the pattern is large. Wobble marking can correspond to larger pattern sizes than brush marking or Pixel stamp marking, and in this case can make the image formation process speedier than with brush or Pixel stamp marking. Depending on the size of the image and the laser speed used, the time needed for emitting a laser burst can be shorter than that required for relative movement, which means that the complete marking time is shorter the lower the number of relative movements. On the other hand, greater energy per pulse is theoretically required to obtain the same contrast since the pattern then comprises more marks to be marked. It is to be noted that it is also theoretically possible to increase the number of pulses per processing burst without significantly increasing production time. The terms «significantly higher» or «significantly lower» can be understood herein to mean 10 times higher or 10 times lower respectively.

One advantage of using this type of marking lies in the marking of one same 2D code on different parts. From the 2D code forming the image, the positions of the filled cells are identified. The content of a filled cell is divided according to a repetition of one same fragment, so that the filling of the cell is composed of the sole repetition of this fragment.

The pattern is chosen to be the repetition of the fragment at the different identified positions. In this manner, at each processing step, a fragment of each filled cell of the image is marked on the part. The relative movements between two micro-machining steps then take place over a distance allowing movement from one fragment to the next i.e. over a distance less than than the size of the pattern, and even less than the size of a cell. On each new processing, a new fragment is formed in each cell. When the number of processing operations performed is equal to the number of fragments repeated in a filled cell, the image is completed.

The number of processing steps needed to obtain the image is therefore equal to the number of repetitions of the fragment to fill the cell. This number of repetitions can easily be adapted. Between two parts to be marked with the same 2D code, it is not necessary, although possible, to modify shaping by the modulator, the pattern being the same for each of these parts.

In addition, the forming of a said pattern that is smaller or comprising fewer marks (for images composed of a plurality of marks) than the final image, requires lesser energy compared with marking of the final image without decomposition per pattern (in a proportion substantially close to the number of fragments repeated in a filled cell). The marking of said pattern can be obtained by a single pulse of the light beam. In addition, a wide choice of light sources is able to be used to obtain said marking. It is thus possible to reach relatively short marking times, typically of less than one second. Finally, the size of the final image is not limited by the size of the pattern.

Repetition of a Second Pattern

The image, in addition to the repetition of a first pattern, can comprise the repetition of a second pattern. This second pattern also comprises at least two local contrast maxima, and can be discrete or continuous. In this case, the method may further comprise performing of the following steps:
processing the second pattern on a surface or in a volume of the part by shaping and focusing a pulsed coherent light beam;
carrying out at least one cycle of the following steps.
   moving the beam and the part relative to each other; and
   processing the second pattern on the surface or in the volume by shaping and focusing the beam.

The method used to carry out repetition of the first pattern in the image is used a second time and adapted to obtain the repetition this time of the second pattern. In this situation, it is necessary to modify shaping by the modulator between forming of the first pattern and forming of the second pattern. It is to be noted that the method can further modified, on the same basis, to carry out other repetitions of one (or more) additional patterns.

Computation of a Set Modulation Value

In the prior art, beam shaping is mentioned according to preestablished, even fixed beam shapes. In other words, the pattern that is able to be marked must be chosen from among a limited number of possible pattern shapes. The patterns that are able to be marked are therefore limited as to shape, and therefore limited by extension as to image possibilities and/or associated marking time. The use of a SLM modulator makes it possible to modify the shape of the pattern, even during the forming process of the image itself. This modification can be dynamic.

It is particularly possible to integrate control software having background processing of all the mathematical notions required to transfer the pattern desired by the user as a laser pattern through a focusing lens, using the modulation device. The laser pattern in the working plane, via its equivalent in the shaping plane i.e. the spatial distribution of light energy, can be defined so that it is only composed of a plurality of sub-beams similar to a pixelized image (each pixel of this laser shape then represents a possible laser impact point or impact surface that can be activated at will by the operator). This approach particularly facilitates control over laser/material interaction, but also facilitates comprehension by the end user for simple transforming of a single usual beam into a plurality of sub-beams.

It is therefore possible to add a step to the method of forming the image, such as presented up until now, to compute a set modulation value from a set input value corresponding to a desired new pattern shape, for example a second pattern repeated in the image. The set modulation value is imposed on the modulation device to carry out beam shaping. This shaping is dynamic shaping of the light beam. The step of sending the set input value and/or the computing step can be performed even when the forming process is in progress.

Non-Repeated Additional Pattern

The image, in addition to repetition of the first pattern, may comprise one or more additional patterns which are not repeated in the image. Each additional pattern can in particular be formed of a plurality of marks. In this case, the method may further comprise processing of the additional pattern on a surface or in the volume of the part by shaping and focusing a pulsed coherent light beam, the forming of the additional pattern on the part comprising the emission of a pulse train of the light beam, each train comprising a finite number of pulses strictly lower than the number of marks forming the additional pattern.

This type of marking, which is not based on repetition of a pattern, was presented in detail in application WO2016001335A. In the remainder hereof it is designated by the term «stamp» marking. Said method allowing the marking both of the repetition of a pattern and an additional non-repeated pattern in the image can be used in particular for the obtaining of secure QR-codes. This method forms a third embodiment of the invention.

Forming a Secure QR-Code on a Polymer

A secure QR-code is a QR-code within which there are integrated one or more proprietary codes, for example secure proprietary markings described in application WO2010034897A1, to secure the entire QR-code. FIG. 6 illustrates a QR-code comprising three secure proprietary markings, and FIG. 7 is a detailed view of one of these secure markings.

An example is given here of this QR-code produced on a part in polymers (POLYAMIDE 6 and Polycarbonate) at ambient temperature. The 2D code of QR-code type can have varying content and is of a typical size of between 1 and 10 cm. In this example, each secure proprietary marking is obtained using a mode close to stamp marking and the remainder of the image is marked in brush marking mode or Pixel stamp marking.

Having regard to the target time of complete marking (less than one second), to the behaviour of the material under laser irradiation, and to the limitations of currently available lasers, these secure proprietary markings cannot be marked by a single stamp marking. Therefore, in this example each secure proprietary marking is itself divided into four sub-assemblies so that:
each marking point is marked using a laser sub-beam, and
each marking point belongs only to a unique sub-assembly.

Each sub-assembly is therefore marked by stamp marking preferably with a unique laser pulse. The complete secure proprietary marking is therefore marked by an entanglement of four stamp markings.

The remainder of the image is obtained by brush marking or Pixel stamp marking using a single pattern. This pattern extends over a square and it can be marked by a total of 16×16=256 sub-beams. The distance in the shaping plane from one sub-beam centre to a neighbouring sub-beam centre can have different values. In the optimised case this distance is 25 μm.

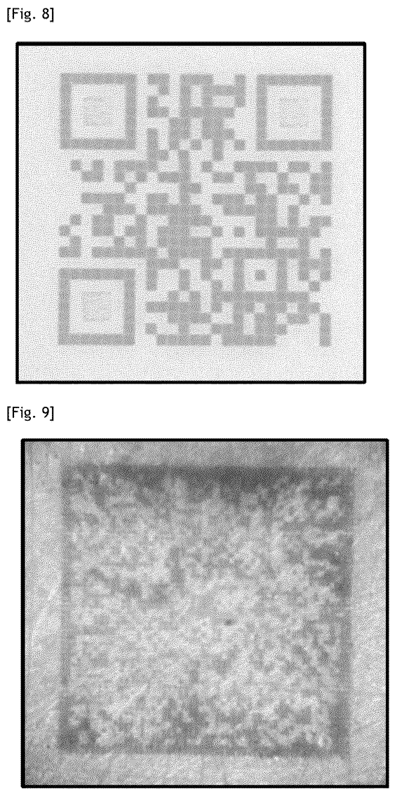

FIG. 8 illustrates the forming of the QR-code illustrated in FIG. 6, and FIG. 9 illustrates the forming of the secure proprietary marking illustrated in FIG. 7. In this example, the light source used is a laser source having the following features:
pulse duration of 7 ns,
visible wavelength (532 nm),
energy per pulse of 5 mJ, and
bursts comprising 1 to 2 laser pulses.

System for Forming an Image on a Part

There is also proposed a processing system allowing the processing of materials according to the method presented in the foregoing. Said system is adapted to form an image on or in a part, the image comprising the repetition of a pattern, the system comprising:
a device for forming the pattern on the surface or in the volume of the part by shaping and focusing a coherent light beam, the pattern comprising at least two local contrast maxima;
a device to move the beam and the part relative to each other.

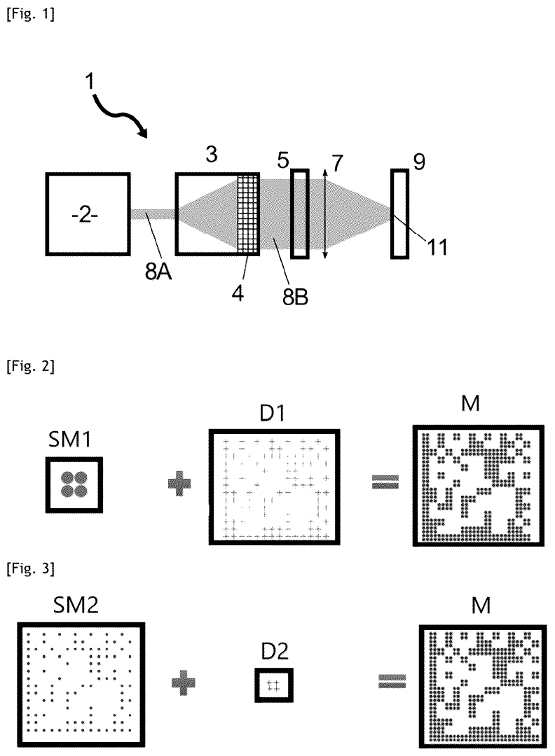

FIG. 1 schematically illustrates one embodiment of said system 1. The device for relative movement of the beam and the part is referenced 5 in FIG. 1. The system 1 comprises the device for forming the pattern on the surface or in the volume of the part by shaping and focusing a coherent light beam which itself comprises:
a source 2 of a coherent light beam 8A, as laser source,
an optical modulation device 3 comprising means 4 to modulate the light beam in a modulation plane according to at least one phase modulation, to shape the light beam into a laser pattern;
a focusing device 7 arranged to focus the light beam shaped by the modulation device in a focusing plane, the focusing plane having Fourier or Fresnel configuration relative to the modulation plane of the modulation device.

The system is adapted to receive a part to be processed, so that the forming of the pattern on the surface or in the volume takes place in a processing plane, the processing plane being separated from the focusing plane by a distance less than or equal to one half of a focal length of the focusing device, the laser pattern being configured to produce processing of the part in the processing plane according to the pattern. The laser beam can be pulsed. The optical modulation device can be a dynamic SLM or else fixed shaping optics.

The optical modulation device and the focusing device can be grouped together in a single apparatus. The relative motion device can be a galvanometer scan head device or an assembly of translation stages. The relative motion device can be positioned on the pathway of the beam as illustrated in FIG. 1, or else underneath the part. The Fourier configuration was described in application WO2016001335A1.

On leaving the modulation device 3, the light beam 8B is shaped according to the laser pattern to produce the pattern 11 in the processing plane where the pattern is to be formed on the surface or in the volume of the part 9 to be marked. This processing plane lies in the vicinity of the focusing plane of the laser beam i.e. the processing plane is separated from the focusing plane by a distance less than or equal to one half of a focal length of the focusing device, the focusing device defining the position of the focusing plane.

The system may also comprise electronics to control the modulation device and/or the light beam source and/or management of a database and/or graphic interfacing for communication with the operator or the other constituent elements of the processing installation. Pattern shapes can be recorded in a database. The system may further comprise means to compute a set modulation value from a set input value corresponding to a desired pattern shape.

1. A method for forming an image on a surface or in a volume of a part, the image comprising a repetition of a pattern, the pattern comprising at least two local contrast maxima, the method comprising:
forming a first realization of the pattern on the surface or in the volume of the part by shaping and focusing a coherent light beam, the first realization of the pattern being positioned on a surface non-parallel to a direction of propagation of the beam;
carrying out at least once a cycle of the following steps:
moving the beam and the part relative to each other, and
forming a second realization of the pattern on the surface or in the volume of the part by shaping and focusing the beam, so that the first realization and second realization do not overlap.

2. The method according to claim 1, wherein the pattern comprises a plurality of spatially separated marks.

3. The method according to claim 2, wherein the coherent light beam is pulsed, each forming of the pattern comprising the emission of a burst of at least one laser pulse, each burst comprising a number of laser pulses inferior to the number of marks forming comprised in the pattern.

4. The method according to claim 3, wherein each burst comprises a single laser pulse.

5. The method according to claim 1, wherein the image represents a one- or two-dimensional code composed of an assembly of empty cells and filled cells, the cells being located at predetermined positions.

6. The method according to claim 5, wherein the filled cells comprise the pattern one or more times.

7. The method according to claim 1, wherein moving the beam and the part relative to each other is performed over a length greater than a dimension of the pattern.

8. The method according to claim 1, wherein moving the beam and the part relative to each other is performed over a length less than a dimension of the pattern.

9. The method according to claim 1, wherein the pattern is a first pattern, the image comprises a repetition of a second pattern, the second pattern comprising at least two local contrast maxima, the method further comprising the following steps:
forming a first realization of the second pattern on the surface or in the volume of the part by shaping and focusing a coherent light beam, the first realization of the second pattern being positioned on a surface non-parallel to a direction of propagation of the beam;
carrying out at least once a cycle of the following steps:
moving the beam and the part relative to each other, and
forming a second realization of the second pattern on the surface or in the volume of the part by shaping and focusing the beam, so that the first realization of the second pattern and the second realization of the second pattern do not overlap.

10. The method according to claim 1, wherein the image comprises an additional pattern formed of a plurality of marks, the method further comprising the forming of the additional pattern on the surface or in the volume of the part by shaping and focusing a pulsed coherent light beam, wherein the forming of the additional pattern on or in the part comprises the emission of a pulse train of the light beam, each train comprising a finite number of pulses strictly inferior to the number of marks forming the additional pattern.

11. The method according to claim 1, wherein the part is in glass, in metal, in plastic, or polymer.

12. The method according to claim 1 which comprises, when forming the pattern, the modifying of a first layer of material by exposure to the laser, to expose a second layer lying underneath the first layer.

13. The method according to claim 1, wherein the forming of the pattern on the surface or in the volume takes place on a processing plane, the processing plane being separated from a focusing plane of the laser beam by a distance inferior or equal to one half of a focal length of a focusing device, the focusing device defining the position of the focusing plane.

14. The method according to claim 1, further comprising a step to compute a set modulation value from a set input value corresponding to the pattern, the set modulation value being provided to a modulation device configured to perform the shaping of the beam based on the set modulation value.

15. A system for forming an image on a surface or in a volume of a part, the image comprising a repetition of a pattern, the system comprising:
a device for forming the pattern on the surface or in the volume of the part by shaping and focusing a coherent light beam, the pattern comprising at least two local contrast maxima, the pattern being placed on a surface non-parallel to a direction of propagation of the beam; and
a device to move the beam and the part relative to each other.

16. The system according to claim 15, wherein the device for forming the pattern on the surface or in the volume of the part by shaping and focusing a coherent light beam comprises:
a source of a coherent light beam;
an optical modulation device comprising a modulation device configured to modulate the light beam in a modulation plane according to at least one phase modulation to shape the light beam according to a laser pattern;
a focusing device configured to focus the light beam shaped by the modulation device in a focusing plane, the focusing plane having Fourier or Fresnel configuration relative to the modulation plane of the modulation device,
the system being adapted to receive the part, so that the forming of the pattern on the surface or in the volume takes place in a processing plane, the processing plane being separated from the focusing plane by a distance less than or equal to one half of a focal length of the focusing device, the laser pattern being configured to produce processing of the part in the processing plane according to the pattern.

17. The system according to claim 15, wherein the laser beam is pulsed.

18. The system according to claim 15, wherein the optical modulation device comprises fixed shaping optics.

19. The system according to claim 18, wherein the optical modulation device and focusing device are grouped together in a single apparatus.

20. The system according to claim 15, wherein the relative motion device comprises a galvanometer scan head.

21. The system according to claim 15, wherein the relative motion device comprises at least one translation stage.

22. A part comprising an image formed by the method according to claim 1.
